(19) United States
(12) Patent Application Publication
(10) Pub. No.: US 2024/0393579 A1
(43) Pub. Date: Nov. 28, 2024

(54) DRIVING MECHANISM

(71) Applicant: TDK TAIWAN CORP., Taoyuan City (TW)

(72) Inventors: Pai-Jui CHENG, Taoyuan City (TW); Shu-Shan CHEN, Taoyuan City (TW); Chuan-Min LEE, Taoyuan City (TW)

(21) Appl. No.: 18/617,936

(22) Filed: Mar. 27, 2024

Related U.S. Application Data
(60) Provisional application No. 63/469,263, filed on May 26, 2023.

(30) Foreign Application Priority Data
Jan. 5, 2024 (CN) 202420031493.4

(51) Int. Cl. G02B 26/08; G02B 7/02

(52) U.S. Cl. CPC G02B 26/0875; G02B 7/021; G02B 7/025

(57) ABSTRACT

A driving mechanism is provided, including a fixed part, an optical element, and a driving assembly. The optical element is movably connected to the fixed part. The driving assembly is disposed in the fixed part for moving the movable part relative to the fixed part along the first axis.

### CROSS REFERENCE TO RELATED APPLICATIONS

This application claims the benefit of U.S. Provisional Application No. 63/469,263, filed May 26, 2023 and China Patent Application No. 202420031493.4, filed on Jan. 5, 2024, the entirety of which are incorporated by reference herein.

### BACKGROUND OF THE INVENTION

### Field of the Invention

The present invention relates to a driving mechanism, and, in particular, to a driving mechanism that drives an optical element to move.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

It can be difficult to reduce the size of a shutter or an aperture mechanism in the camera module of some electronic devices. Additionally, the movable mechanism inside these electronic devices may be damaged when the unit collides with external objects. Addressing these problems has become a challenge.

### BRIEF SUMMARY OF THE INVENTION

An embodiment of the present invention provides a driving mechanism that includes a fixed part, an optical element, and a driving assembly. The optical element is movably connected to the fixed part. The driving assembly is disposed in the fixed part for moving the movable part relative to the fixed part along the first axis.

In some embodiments, the driving mechanism further includes a first conductive element, wherein the fixed part includes a housing and a base connected to each other, the first conductive element is disposed on the base and has a first stopper that is angled relative to the first axis, and when the optical element is in a first position, the first stopper is in contact with the optical element.

In some embodiments, wherein the optical element comprises conductive material, and when the optical element is in the first position, the first conductive element and the optical element are electrically connected to each other so that the first electrical signal is transferred to an external circuit.

In some embodiments, the driving mechanism further includes a plurality of first conductive elements disposed on opposite sides of the optical element.

In some embodiments, wherein the first conductive element further has a first guiding structure parallel to the first axis, and the optical element is guided by the first guiding structure to move relative to the base along the first axis.

In some embodiments, the driving mechanism further includes a second conductive element disposed on the base and having a second stopper that is angled relative to the first axis, wherein when the optical element is in a second position, the second stopper is in contact with the optical element.

In some embodiments, wherein the optical element comprises conductive material, and when the optical element is in a second position, the second conductive element and the optical element are electrically connected to each other so that a second electrical signal is transferred to an external circuit.

In some embodiments, the driving mechanism further includes a plurality of second conductive elements disposed on opposite sides of the optical element.

In some embodiments, wherein the second conductive element further has a second guiding structure parallel to the first axis, and the optical element is guided by the second guiding structure to move relative to the base along the first axis.

In some embodiments, wherein the optical element has a connecting portion connected to the driving assembly, and the first stopper is in contact with the first end surface of the connecting portion when the optical element is in the first position.

In some embodiments, wherein the second stopper is in contact with the second end surface of the connecting portion when the optical element is in the second position, and the first and second end surfaces are on opposite sides of the connecting portion.

In some embodiments, wherein the housing has an opening blocked by the optical element when the optical element is in the first position.

In some embodiments, the driving mechanism further includes a support, a circuit board, and a plurality of optical lenses, wherein the optical lenses are disposed on the circuit board, the support is disposed on the optical lenses and is in contact with the optical element.

In some embodiments, wherein a gap is formed between the optical element and the optical lenses.

In some embodiments, wherein the base is disposed on the circuit board.

In some embodiments, the driving mechanism further includes a first conductive element and a conductive glue, wherein the fixed part includes a housing and a base connected to each other, the first conductive element is disposed on the base, the conductive glue is disposed on the optical element, the first conductive element has a nub, and the optical element comprises conductive material, wherein the nub is in contact with the conductive glue when the optical element is in the first position.

In some embodiments, wherein the nub and the conductive glue remain in contact with each other for a period of time exceeding 0.01 seconds, the driving assembly is disabled and stops the optical element from moving.

In some embodiments, wherein the optical element forms a recess, the conductive glue is received in the recess, and the nub protrudes into the recess when in contact with the conductive glue.

In some embodiments, wherein when the central axis of the nub is aligned with the central axis of the conductive glue, the optical element is spaced apart from the fixed part along the first axis.

In some embodiments, wherein the conductive glue protrudes from the optical element, and the nub is spaced apart from the optical element.

In some embodiments, the driving mechanism further includes a piezo actuator, a driving shaft, and a connecting member, wherein the driving shaft is connected to the piezo actuator, and the connecting member is connected between the driving shaft and the optical element.

In some embodiments, wherein the connecting member comprises a metal clip slidably disposed on the driving shaft.

### BRIEF DESCRIPTION OF THE DRAWINGS

The present invention can be more fully understood by reading the subsequent detailed description and examples with references made to the accompanying drawings, wherein:

FIG. 1 shows an exploded view of a driving mechanism 100 in accordance with an embodiment of the invention.

FIG. 2 shows another exploded view of the driving mechanism 100 in FIG. 1.

FIG. 3 shows a perspective diagram of the driving mechanism 100 in FIGS. 1 and 2.

FIG. 4 shows another perspective diagram of the driving mechanism 100 in FIGS. 1 and 2.

FIG. 5 is perspective diagram showing the connecting member 20 and the optical element 30 of FIG. 1 when in the first position.

FIG. 6 is a perspective diagram showing the piezo actuator P, the driving shaft C, and the connecting member 20 disposed in the receiving space 401 of the base 40.

FIG. 7 shows an exploded view of the piezo actuator P, the driving shaft C, and the connecting member 20, and the base 40 before assembly.

FIG. 8 shows an exploded view of the first conductive elements P11, P12, the second conductive elements P21, P22, the third conductive elements P31, P32, and the base 40 before assembly.

FIG. 9 shows a perspective diagram of the first conductive elements P11, P12, the second conductive elements P21, P22, the third conductive elements P31, P32, and the base 40 after assembly.

FIG. 10 is a partial enlarged perspective view showing that the first stoppers P112, P122 of the first conductive elements P11, P12 are in contact with the first end surface 302 of the connection portion 301 of the optical element 30 when the connecting member 20 and the optical element 30 are in the first position.

FIG. 11 is a cross-sectional view showing that the first stoppers P112, P122 of the first conductive elements P11, P12 are in contact with the first end surface 302 of the connection portion 301 of the optical element 30 when the connecting member 20 and the optical element 30 are in the first position.

FIG. 12 is an enlarged perspective view showing that the second stoppers P212, P222 of the second conductive elements P21, P22 are in contact with the second end surface 303 of the connection portion 301 of the optical element 30 when the connecting member 20 and the optical element 30 are in the second position.

FIG. 13 is a cross-sectional view showing that the second stoppers P212, P222 of the second conductive elements P21, P22 are in contact with the second end surface 303 of the connection portion 301 of the optical element 30 when the connecting member 20 and the optical element 30 are in the second position.

FIG. 14 is a perspective diagram showing that light L propagates through the openings 11 and 12 of the housing 10 to the optical lenses N1 and N2 inside the electronic device when the connecting member 20 and the optical element 30 are in the second position.

FIG. 15 is a schematic diagram showing that a support 50 is disposed between the optical lenses N1 and N2 and the optical element 30.

FIG. 16 is a cross-sectional view showing a nub G formed on the second guiding structure P211 of the second conductive element P21 and in contact with the conductive glue 60 on the optical element 30, in accordance with another embodiment of the invention.

FIG. 17 is a cross-sectional view showing the nub G before contacting the conductive glue 60 on the optical element 30.

FIG. 18 is a cross-sectional view showing the nub G when in contact with the conductive glue 60 on the optical element 30.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

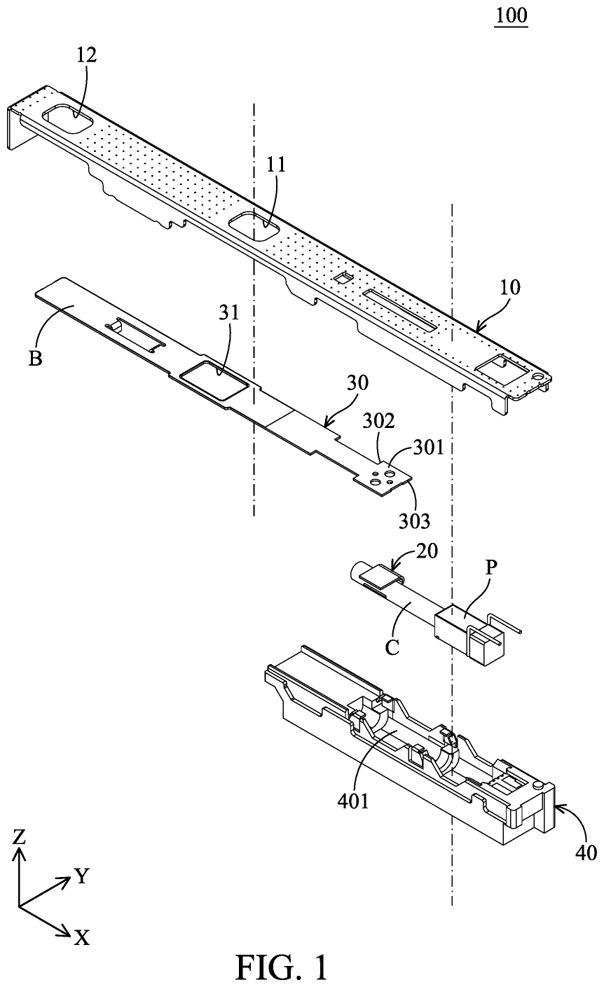

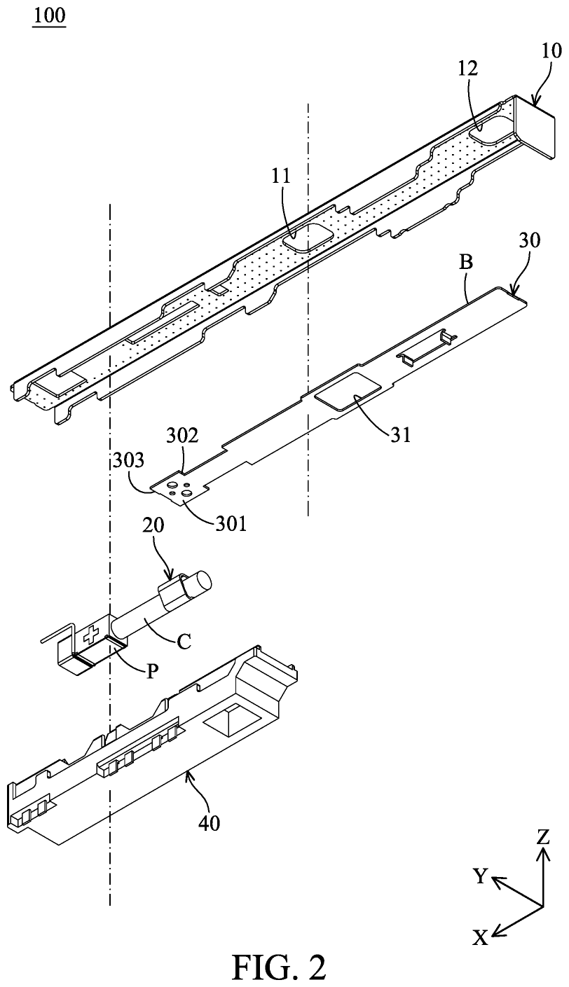

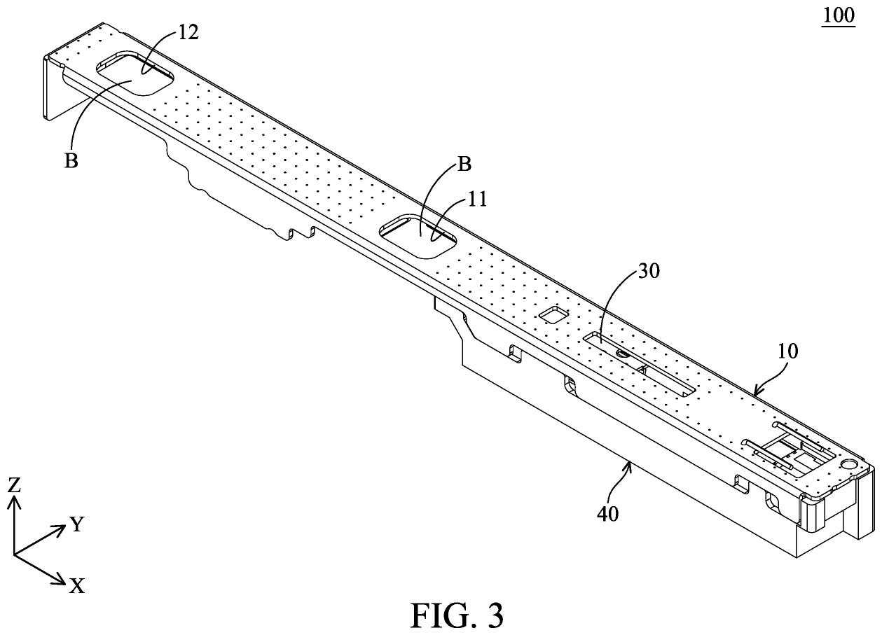

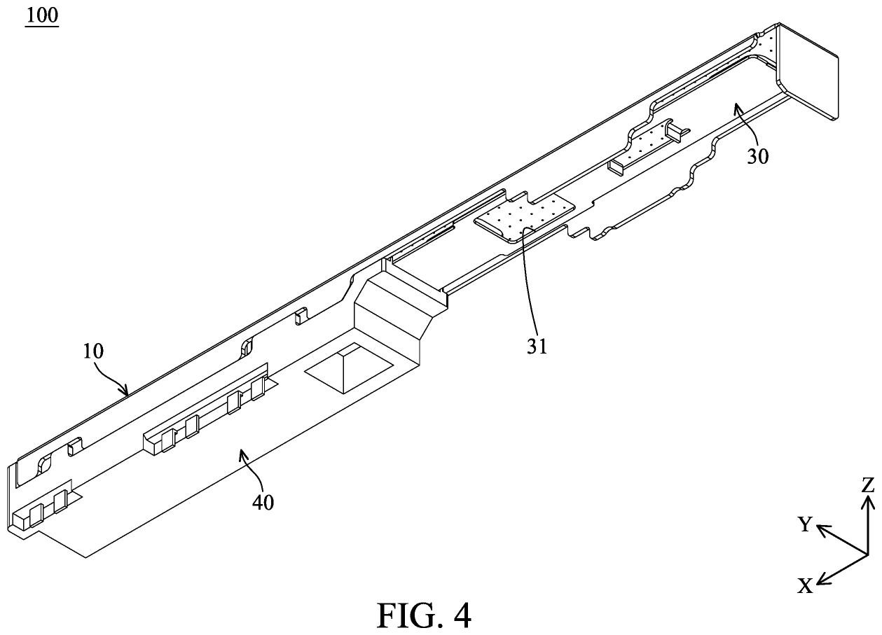

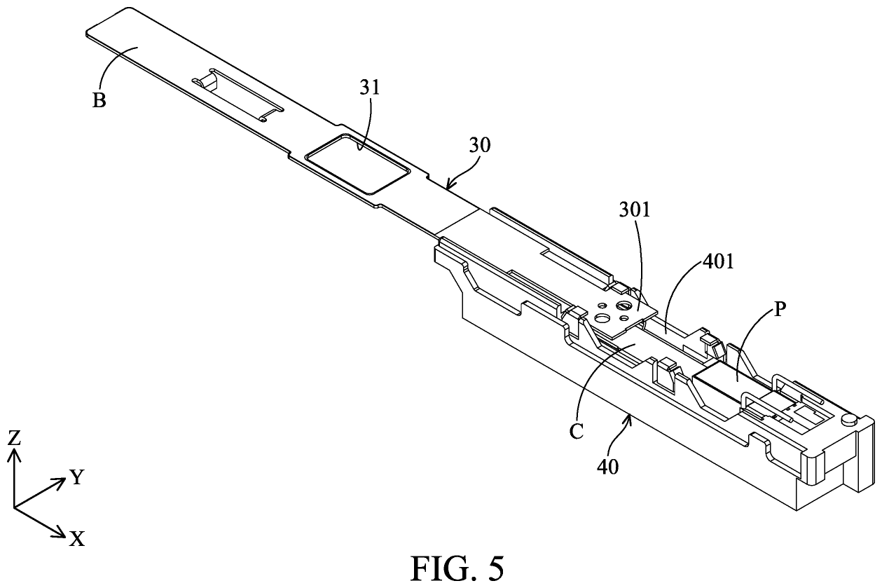

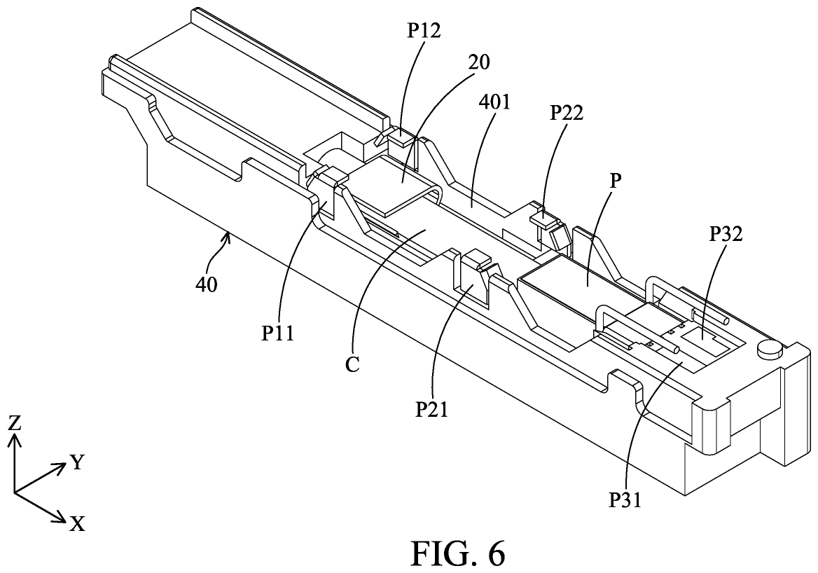

FIG. 1 shows an exploded view of a driving mechanism 100 in accordance with an embodiment of the invention. FIG. 2 shows another exploded view of the driving mechanism 100 in FIG. 1. FIG. 3 shows a perspective diagram of the driving mechanism 100 in FIGS. 1 and 2. FIG. 4 shows another perspective diagram of the driving mechanism 100 in FIGS. 1 and 2. FIG. 5 is perspective diagram showing the connecting member 20 and the optical element 30 of FIG. 1 when in the first position. FIG. 6 is a perspective diagram showing the piezo actuator P, the driving shaft C, and the connecting member 20 disposed in the receiving space 401 of the base 40.

Referring to FIGS. 1-6, an embodiment of the driving mechanism 100 may be disposed in a cell phone, laptop computer, or other electronic devices. The driving mechanism 100 primarily comprises a housing 10, a connecting member 20, an optical element 30, a hollow base 40, a piezo actuator P, and a driving shaft C. The piezo actuator P, the driving shaft C, and the connecting member 20 are accommodated in the receiving space 401 of the base 40 (FIG. 6).

In some embodiments, the optical element 30 optical element 30 may comprise light shading material, and it can be used as a camera shutter blade to block light from entering the driving mechanism 100 through the openings 11 and 12 of the housing 10 to an optical lens (not shown) in the electronic device.

The housing 10 and the base 40 are affixed to each other, thus forming a fixed part of the driving mechanism 100. Two openings 11 and 12 are formed on the housing 10, and a through hole 31 is formed on the optical element 30.

It should be noted that the optical element 30 is movable relative to the housing 10 and the base 40 along the X axis (the first axis). When the optical element 30 is in the first position (FIG. 3), the shielding portion B of the optical element 30 can block the openings 11 and 12 of the housing 10, thereby preventing light from entering the driving mechanism 100.

In this embodiment, the piezo actuator P comprises piezoelectric material, and the driving shaft C comprises a carbon fiber rod, wherein an end of the driving shaft C is connected to the piezo actuator P. When a current signal is applied to the piezo actuator P from an external circuit, the driving shaft C can be impelled by the piezo actuator P along the central axis thereof (X direction).

As shown in FIGS. 1, 2, and 6, the connecting member 20 may be a metal clip that is slidably disposed on the driving shaft C. The connecting member 20 is adhered to the connection portion 301 of the optical element 30. The connecting member 20, the driving shaft C, and the piezo actuator P constitute a driving assembly for impelling the optical element 30 relative to the housing 10 and the base 40 (fixed part).

When a current signal is applied to the piezo actuator P from the external circuit, the piezo actuator P can vibrate the driving shaft C, whereby the connecting member 20 and the optical element 30 are forced to move relative to the housing 10 and the base 40 (fixed part) along the X axis (first axis).

In this embodiment, the width of the connecting member 20 along the X axis (first axis) is less than the distance between the first end surface 302 and the second end surface 303 of the connection portion 301 of the optical element 30. However, the width of the connecting member 20 may be adjusted depending on design requirements, and it is not limited to the embodiments as described above.

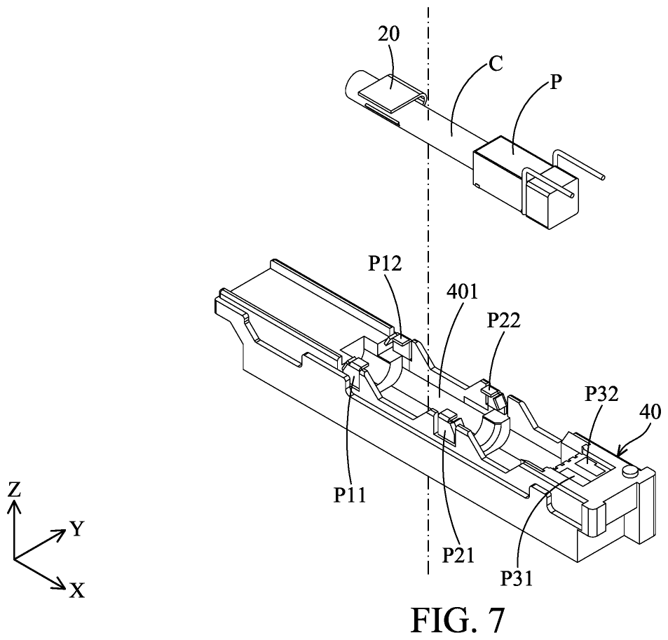

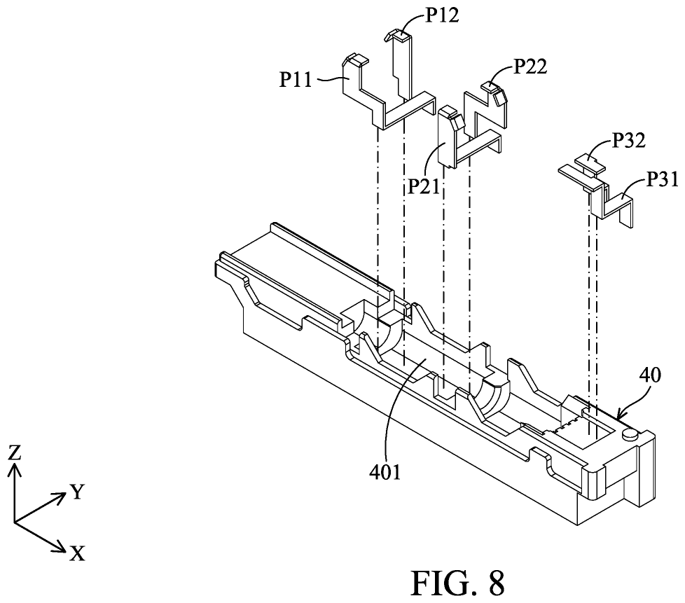

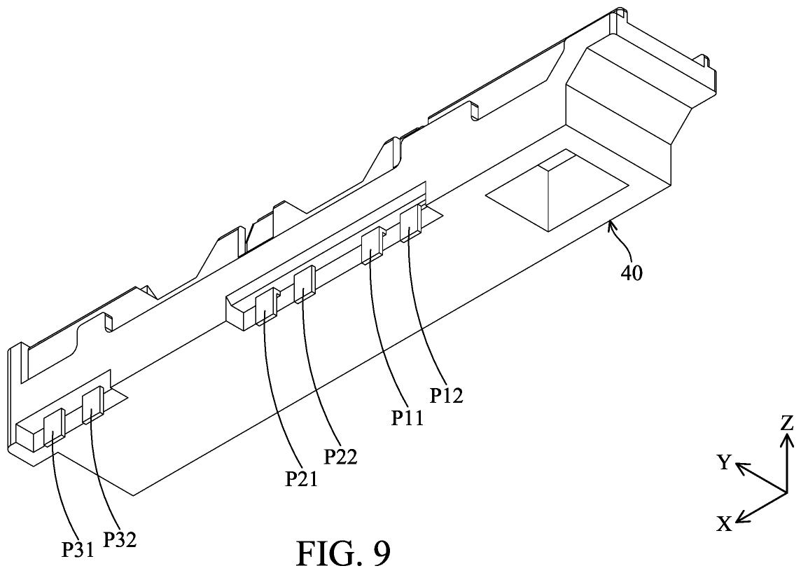

FIG. 7 shows an exploded view of the piezo actuator P, the driving shaft C, and the connecting member 20, and the base 40 before assembly. FIG. 8 shows an exploded view of the first conductive elements P11, P12, the second conductive elements P21, P22, the third conductive elements P31, P32, and the base 40 before assembly. FIG. 9 shows a perspective diagram of the first conductive elements P11, P12, the second conductive elements P21, P22, the third conductive elements P31, P32, and the base 40 after assembly.

Referring to FIGS. 6-9, the driving mechanism 100 comprises a pair of first conductive elements P11, P12, a pair of second conductive elements P21, P22, and a pair of third conductive elements P31, P32 that are integrally formed with the plastic base 40 by insert molding.

Specifically, as shown in FIG. 7, the top ends of the first conductive elements P11 and P12 are located on opposite sides of the driving shaft C. The top ends of the second conductive elements P21 and P22 are also located on opposite sides of the driving shaft C. The third conductive elements P31 and P32 are exposed to the top side of the base 40 and electrically connected to the piezo actuator P.

It can be seen in FIG. 9 that the lower ends of the first conductive elements P11, P12, the second conductive elements P21, P22, and the third conductive elements P31, P32 are arranged along the X axis (first axis) and exposed to the bottom side of the base 40. Additionally, the lower ends of the first conductive elements P11, P12, the second conductive elements P21, P22, and the third conductive elements P31, P32 protrude from the base in the −Z direction (second axis) for electrical connection to the external circuit.

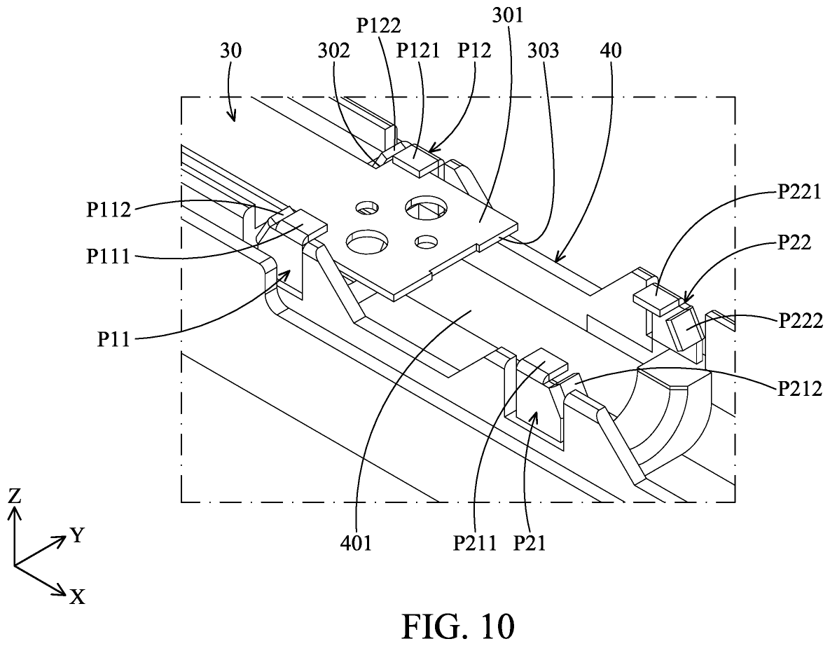

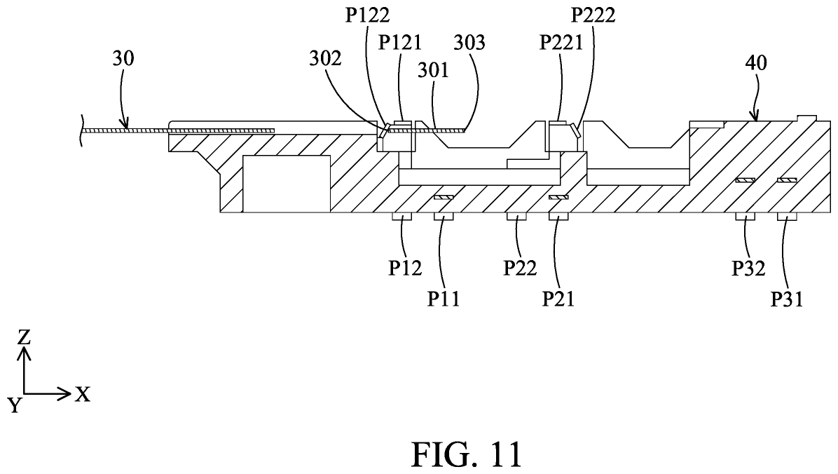

FIG. 10 is a partial enlarged perspective view showing that the first stoppers P112, P122 of the first conductive elements P11, P12 are in contact with the first end surface 302 of the connection portion 301 of the optical element 30 when the connecting member 20 and the optical element 30 are in the first position. FIG. 11 is a cross-sectional view showing that the first stoppers P112, P122 of the first conductive elements P11, P12 are in contact with the first end surface 302 of the connection portion 301 of the optical element 30 when the connecting member 20 and the optical element 30 are in the first position.

Referring to FIGS. 10 and 11, two first guiding structures P111, P121 are respectively formed on the top side of the first conductive elements P11, P12, and they are substantially parallel to the X axis. The first guiding structures P111 and P121 are configured for guiding the optical element 30 to slide along the X axis and preventing the optical element 30 from separation from the base 40.

Moreover, two first stoppers P112, P122 are respectively formed on the top side of the first conductive elements P11, P12. The first stoppers P112, P122 are located close to the first guiding structures P111, P121 and angled relative to the X axis (first axis).

It can be seen in FIGS. 10 and 11 that when the optical element 30 is in the first position, the first stoppers P112, P122 of the first conductive elements P11, P12 are in contact with the first end surface 302 of the connection portion 301 of the optical element 30. Hence, the optical element 30 can be restricted in the first position, and the optical element 30 can be prevented from sliding out of the base 40 along the −X direction and collision with other components in the driving mechanism 100.

As shown in FIG. 3, when the optical element 30 is in the first position, the openings 11 and 12 of the housing 10 are blocked by the shielding portion B of the optical element 30, thereby preventing light from entering the driving mechanism 100.

Since the optical element 30 in this embodiment comprises conductive material such as metal or conductive ink, the first conductive elements P11, P12 can be electrically connected to each other by the optical element 30 and thus transferring the first electrical signal to the external circuit.

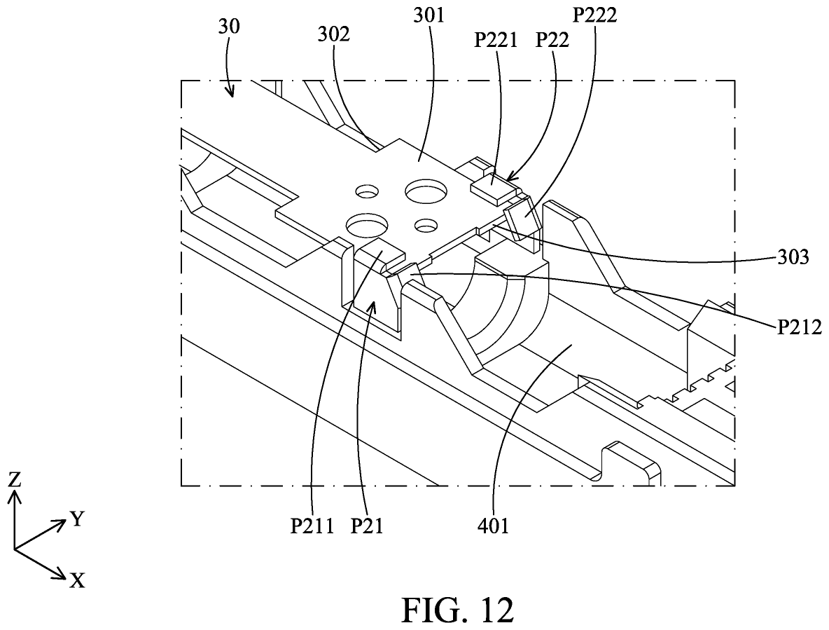

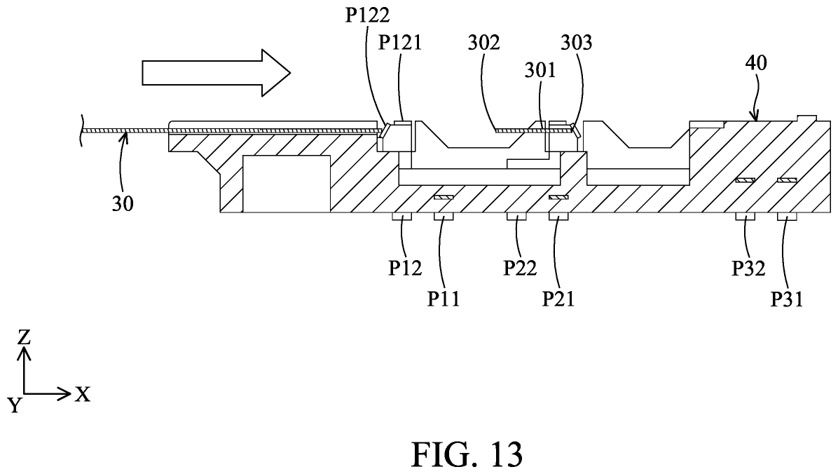

FIG. 12 is an enlarged perspective view showing that the second stoppers P212, P222 of the second conductive elements P21, P22 are in contact with the second end surface 303 of the connection portion 301 of the optical element 30 when the connecting member 20 and the optical element 30 are in the second position. FIG. 13 is a cross-sectional view showing that the second stoppers P212, P222 of the second conductive elements P21, P22 are in contact with the second end surface 303 of the connection portion 301 of the optical element 30 when the connecting member 20 and the optical element 30 are in the second position.

Referring to FIGS. 12 and 13, two second guiding structures P211, P221 are respectively formed on the top side of the second conductive elements P21, P22, and they are substantially parallel to the X axis. The second guiding structures P211 and P221 are configured for guiding the optical element 30 to slide along the X axis and preventing the optical element 30 from separation from the base 40.

Moreover, two second stoppers P212, P222 are respectively formed on the top side of the second conductive elements P21, P22. The second stoppers P212, P222 are located close to the second guiding structures P211, P221 and angled relative to the X axis (first axis).

It can be seen in FIGS. 12 and 13 that when the connecting member 20 and the optical element 30 move from the first position (FIGS. 10 and 11) along the X direction to the second position, the second stoppers P212, P222 of the second conductive elements P21, P22 are in contact with the second end surface 303 of the connection portion 301 of the optical element 30. Hence, the optical element 30 can be restricted in the second position, and the optical element 30 can be prevented from sliding out of the base 40 along the X direction and collision with other components in the driving mechanism 100, wherein the first and second end surfaces 302 and 303 are on opposite sides of the connection portion 301.

In this state, since the optical element 30 comprises conductive material such as metal or conductive ink, the second conductive elements P21, P22 can be electrically connected to each other by the optical element 30 and thus transferring a second electrical signal to the external circuit.

As the first stoppers P112, P122 and the second stoppers P212, P222 are angled relative to the X axis (first axis), slight elastic deformation thereof (the angular deformation is less than 10 degrees) may occur when in contact with the optical element 30. Therefore, physical contact and electrical connection between the optical element 30 and the first conductive elements P11, P12 (or the second conductive elements P21, P22) can be assured, and the reliability of the driving mechanism 100 can be improved.

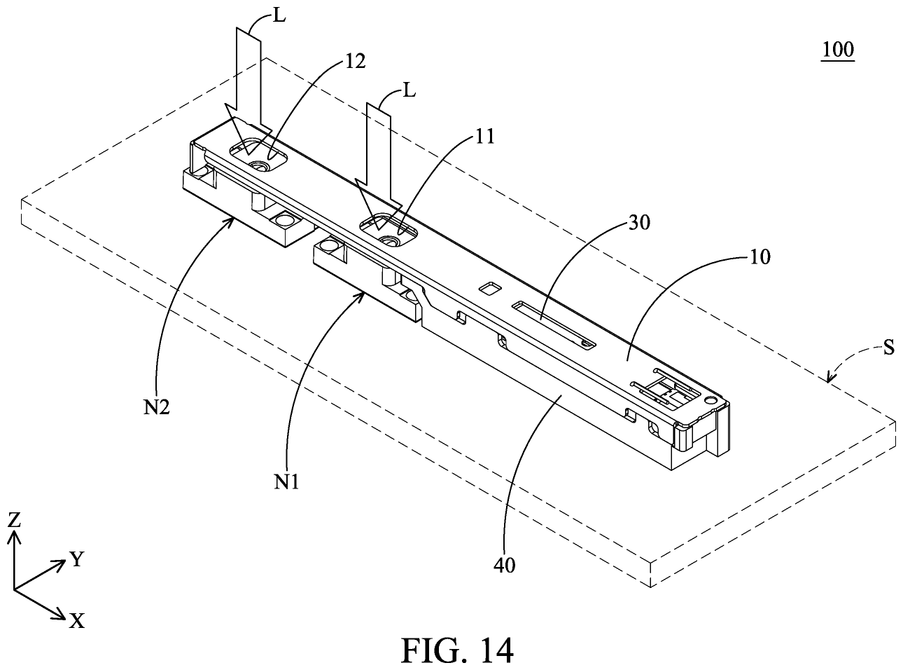

FIG. 14 is a perspective diagram showing that light L propagates through the openings 11 and 12 of the housing 10 to the optical lenses N1 and N2 inside the electronic device when the connecting member 20 and the optical element 30 are in the second position.

Referring to FIG. 14, when the connecting member 20 and the optical element 30 are in the second position, the opening 11 of the housing 10 overlaps the through hole 31 of the optical element 30, and the opening 12 of the housing 10 is not blocked by the optical element 30. In this state, light L can propagate through the openings 11 and 12 of the housing 10 to the optical lenses N1 and N2 inside the electronic device.

In this embodiment, two optical lenses N1 and N2 and a circuit board S are provided in the driving mechanism 100, wherein the base 40 and the optical lenses N1 and N2 are disposed on the circuit board S. Moreover, the first conductive elements P11 and P12, the second conductive elements P21 and P22, and the third conductive elements P31 and P32 are electrically connected to the circuit board S.

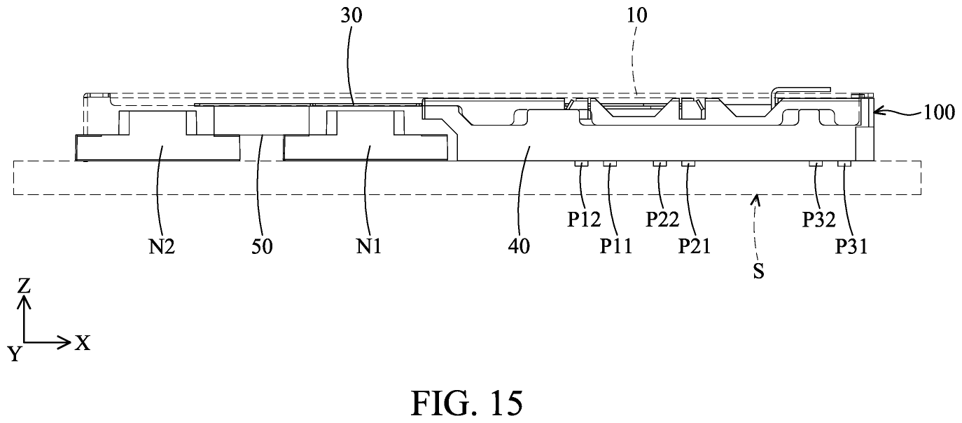

FIG. 15 is a schematic diagram showing that a support 50 is disposed between the optical lenses N1 and N2 and the optical element 30.

To prevent warpage of the optical element 30 when sliding along the X axis, a support 50 (e.g. a plastic block) may be disposed between the optical lenses N1 and N2 and the optical element 30, as shown in FIG. 15. It should be noted that the optical element 30 can be supported stably by the support 50 that is connected between the two optical lenses N1 and N2 and in contact with the optical element 30.

In this embodiment, since the support 50 is higher than the two optical lenses N1 and N2, a gap can be formed between the optical element 30 and the optical lenses N1 and N2. Therefore, the optical element 30 can be prevented from collision with the optical lenses N1 and N2, and the stability of the driving mechanism 100 can also be improved when in use.

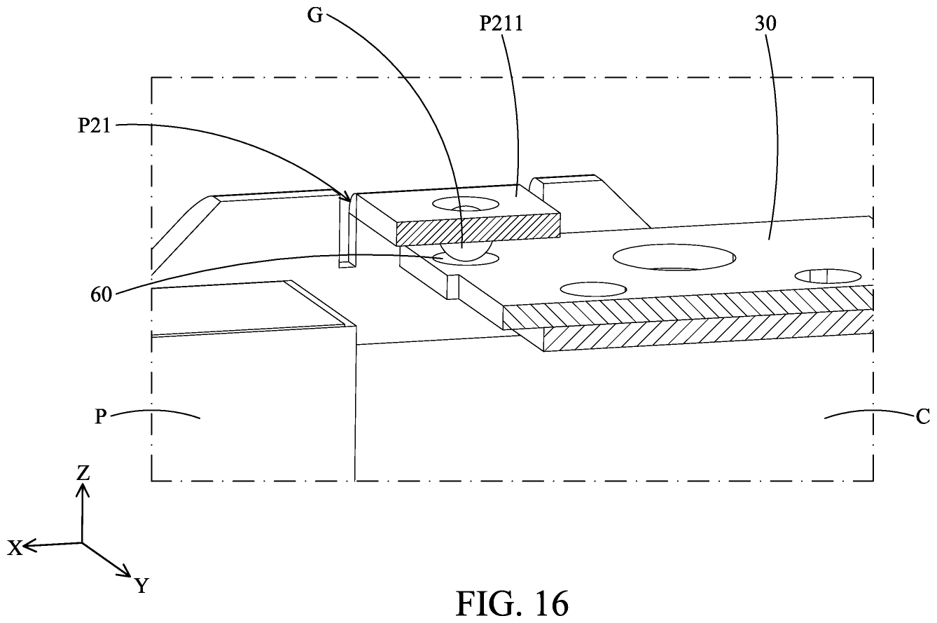

FIG. 16 is a cross-sectional view showing a nub G formed on the second guiding structure P211 of the second conductive element P21 and in contact with the conductive glue 60 on the optical element 30, in accordance with another embodiment of the invention.

In this embodiment of FIG. 16, a nub G is formed on the second guiding structure P211 of the second conductive element P21, and the conductive glue 60 is applied on the optical element 30. When the connecting member 20 and the optical element 30 move from the first position to the second position, the nub G can contact the conductive glue 60 so that the optical element 30 and the second conductive element P21 are electrically connected to each other.

Another nub G may also be formed on the second guiding structure P221 of the other second conductive element P22, and another conductive glue 60 may be disposed on the optical element 30 accordingly. Therefore, when the connecting member 20 and the optical element 30 move from the first position to the second position, the second conductive elements P21, P22 can be electrically connected to each other via the optical element 30, and the second electrical signal can be transferred to the external circuit.

Similarly, the nubs G may also be formed on the first guiding structures P111, P121 of the first conductive elements P11, P12, and the conductive glue 60 may also be disposed on the optical element 30 accordingly. Therefore, when the connecting member 20 and the optical element 30 move to the first position, the first conductive elements P11, P12 can be electrically connected to each other via the optical element 30, and the first electrical signal can be transferred to the external circuit.

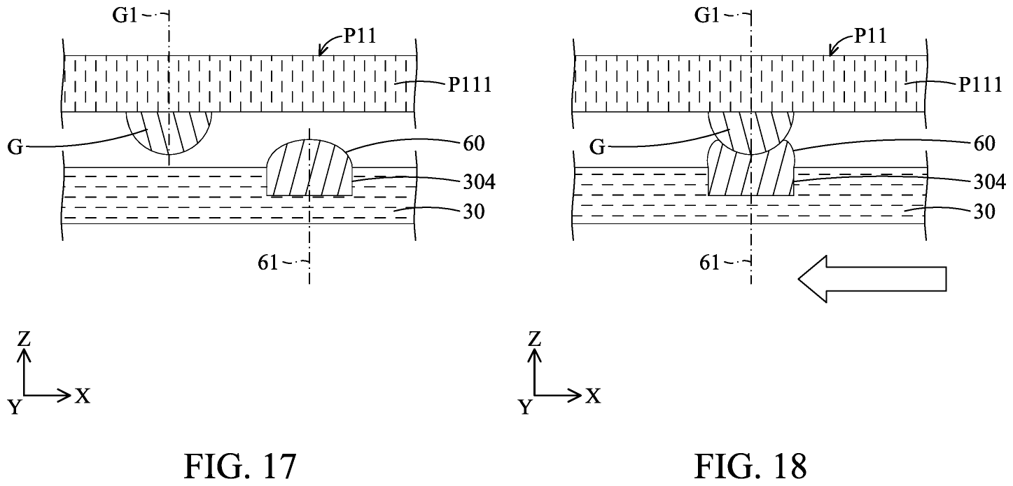

FIG. 17 is a cross-sectional view showing the nub G before contacting the conductive glue 60 on the optical element 30. FIG. 18 is a cross-sectional view showing the nub G when in contact with the conductive glue 60 on the optical element 30.

Referring to FIG. 17, the conductive glue 60 of this embodiment is received in the recess 304 of the optical element 30. Here, the conductive glue 60 protrudes from the upper surface of the optical element 30. Before the nub G on the first guiding structure P111 of the first conductive element P11 forms contact with the conductive glue 60 on the optical element 30, a gap is formed between the nub G and the upper surface of the optical element 30, and the central axis G1 of the nub G is offset from the central axis 61 of the conductive glue 60.

As the optical element 30 moving a certain distance in the −X direction, the nub G on the first guiding structure P111 of the first conductive element P11 forms contact with the conductive glue 60 on the optical element 30, as shown in FIG. 18. In this state, the central axis G1 of the nub G is aligned with the central axis 61 of the conductive glue 60, and the connecting member 20 and the optical element 30 are spaced apart from the housing 10 and the base 40 along the X axis. That is, the housing 10 and the base 40 would not restrict the connecting member 20 and the optical element 30 from moving along the X axis (first axis) when the central axis G1 of the nub G is aligned with the central axis 61 of the conductive glue 60.

It should be noted that when the nubs G on the first conductive elements P11, P12 are in contact with the conductive glue 60 on the optical element 30, the first conductive elements P11, P12 can be electrically connected to each other by the optical element 30, and the first electrical signal can be transferred to the external circuit. When the nubs G and the conductive glue 60 remain in contact with each other for a period of time (e.g. exceeding 0.01 second), the piezo actuator P can be disabled so that the central axis G1 of the nub G aligns with the central axis 61 of the conductive glue 60 as far as possible, whereby the optical element 30 can be positioned in the first position.

Similarly, when the nubs G on the second conductive elements P21, P22 are in contact with the conductive glue 60 on the optical element 30, the second conductive elements P21, P22 can be electrically connected to each other by the optical element 30, and the second electrical signal can be transferred to the external circuit. When the nubs G and the conductive glue 60 remain in contact with each other for a period of time (e.g. exceeding 0.01 seconds), the piezo actuator P can be disabled so that the optical element 30 can be stably positioned in the second position.

In some embodiments, the nub G may protrude into the recess 304 of the optical element 30 when the central axis G1 of the nub G is aligned with the central axis 61 of the conductive glue 60, whereby the nub G can be prevented from slipping off the conductive glue 60. It should be noted that the size of the nub G can be adjusted depending on design requirements, and it is not limited to the embodiments as described above.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism, comprising:
a fixed part;
an optical element, movably connected to the fixed part; and
a driving assembly, disposed in the fixed part for moving the movable part relative to the fixed part along a first axis.

2. The driving mechanism as claimed in claim 1, further comprising a first conductive element, wherein the fixed part includes a housing and a base connected to each other, the first conductive element is disposed on the base and has a first stopper that is angled relative to the first axis, and when the optical element is in a first position, the first stopper contacts the optical element.

3. The driving mechanism as claimed in claim 2, wherein the optical element comprises conductive material, and when the optical element is in the first position, the first conductive element and the optical element are electrically connected to each other so that a first electrical signal is transferred to an external circuit.

4. The driving mechanism as claimed in claim 3, further comprising a plurality of first conductive elements disposed on opposite sides of the optical element.

5. The driving mechanism as claimed in claim 2, wherein the first conductive element further has a first guiding structure parallel to the first axis, and the optical element is guided by the first guiding structure to move relative to the base along the first axis.

6. The driving mechanism as claimed in claim 2, further comprising a second conductive element disposed on the base and having a second stopper that is angled relative to the first axis, wherein when the optical element is in a second position, the second stopper contacts the optical element.

7. The driving mechanism as claimed in claim 6, wherein the optical element comprises conductive material, and when the optical element is in the second position, the second conductive element and the optical element are electrically connected to each other so that a second electrical signal is transferred to an external circuit.

8. The driving mechanism as claimed in claim 7, further comprising a plurality of second conductive elements disposed on opposite sides of the optical element.

9. The driving mechanism as claimed in claim 6, wherein the second conductive element further has a second guiding structure parallel to the first axis, and the optical element is guided by the second guiding structure to move relative to the base along the first axis.

10. The driving mechanism as claimed in claim 6, wherein the optical element has a connecting portion connected to the driving assembly, and the first stopper contacts a first end surface of the connecting portion when the optical element is in the first position.

11. The driving mechanism as claimed in claim 10, wherein the second stopper contacts a second end surface of the connecting portion when the optical element is in the second position, and the first and second end surfaces are on opposite sides of the connecting portion.

12. The driving mechanism as claimed in claim 2, wherein the housing has an opening blocked by the optical element when the optical element is in the first position.

13. The driving mechanism as claimed in claim 2, further comprising a support, a circuit board, and a plurality of optical lenses, wherein the optical lenses are disposed on the circuit board, and the support is disposed on the optical lenses and contacts the optical element.

14. The driving mechanism as claimed in claim 13, wherein a gap is formed between the optical element and the optical lenses.

15. The driving mechanism as claimed in claim 13, wherein the base is disposed on the circuit board.

16. The driving mechanism as claimed in claim 1, further comprising a first conductive element and a conductive glue, wherein the fixed part includes a housing and a base connected to each other, the first conductive element is disposed on the base, the conductive glue is disposed on the optical element, the first conductive element has a nub, and the optical element comprises conductive material, wherein the nub contacts the conductive glue when the optical element is in a first position.

17. The driving mechanism as claimed in claim 16, wherein when the nub and the conductive glue remain in contact with each other for a period of time exceeding 0.01 seconds, the driving assembly is disabled and stops the optical element from moving.

18. The driving mechanism as claimed in claim 16, wherein the optical element forms a recess, the conductive glue is received in the recess, and the nub protrudes into the recess when in contact with the conductive glue.

19. The driving mechanism as claimed in claim 16, wherein when the central axis of the nub is aligned with the central axis of the conductive glue, the optical element is spaced apart from the fixed part along the first axis.

20. The driving mechanism as claimed in claim 16, wherein the conductive glue protrudes from the optical element, and the nub is spaced apart from the optical element.

21. The driving mechanism as claimed in claim 1, further comprising a piezo actuator, a driving shaft, and a connecting member, wherein the driving shaft is connected to the piezo actuator, and the connecting member is connected between the driving shaft and the optical element.

22. The driving mechanism as claimed in claim 21, wherein the connecting member comprises a metal clip slidably disposed on the driving shaft.
